(19) United States
(12) Patent Application Publication
(10) Pub. No.: US 2007/0080815 A1
(43) Pub. Date: Apr. 12, 2007

(54) Apparatus, method, device and computer program product for audibly communicating medicine identity, dosage and intake instructions

(75) Inventor: Jay Steinmetz, Baltimore, MD (US)

Correspondence Address: TOWNSEND & BANTA;c/o PORTFOLIO IP, PO BOX 52050, MINNEAPOLIS, MN, 55402, US

(73) Assignee: Barcoding, Inc.

(21) Appl. No.: 11/523,464

(22) Filed: Sep. 15, 2006

Related U.S. Application Data
(60) Provisional application No. 60/724,280, filed on Oct. 7, 2005.

(51) Int. Cl. G08B 23/00

(52) U.S. Cl. 340/573.1

(57) ABSTRACT

A device, method, and computer software product are provided for communicating medicine dosage and intake instructions to a user by labeling a medicine container with a tag containing a unique identifier, associating the unique identifier with an audio file comprising instructions related to medicine usage, and delivering the audio file to a electromagnetic wave-enabled device. The electromagnetic wave-enable device, such as a mobile telephone or PDA, via a service, plays an audio file associated with the unique identifier when the RFID tag is read by said device.

### BACKGROUND OF THE INVENTION

Improving medication compliance is a universal healthcare goal in patient care. However, the process of ensuring medicament compliance is an ongoing struggle that requires strict adherence to a routine dosage regime. Difficulties in managing daily medication regime may be exacerbated by age and physical disabilities, such as visual impairment. The vast majority of individuals who generally have medication compliance and adherence problems due to visual impairments are elderly patients. Visual impairment typically exacerbates the difficulties in explaining medication regimens to this patient population, thus resulting in non-compliance or self-care error. In some instances, the elderly, blind or visually impaired face severe and sometimes dangerous challenges in managing their own self-care and medication schedule.

According to the American Foundation for the Blind, estimates of the number of people with difficulty seeing (even when using one's usual eyeglasses) range from as low as 7 million to as high as 20 million people (all ages). There is greater consistency in estimates of the number of people with very severe visual impairment, which is estimated as approximately 1.5 million to 2 million people. When used correctly, prescribed medications have the potential of greatly improving the health and independence of individuals who are blind or visually impaired.

Access to drug information, including drug labels and usage instructions, is an important component to improving medication compliance. As the number of prescribed or recommended medications and/or vitamins and supplements increases for any individual patient, the difficulty in managing the proper dosing regime also increases. Prescriptions differ in quantity, daily dosages and other requirements, such as a medication requiring concurrent food intake. As a patient's need for drug information increases, so to does their need for assistance in the management of their intake regimes. In most cases, blind or visually-impaired individuals are generally assisted by a caregiver, who instructs these individuals on how to take their medications and other counseling information provided by the pharmacists and doctors.

In the absence of a caregiver, providing drug information to the visually impaired population is practically challenging. A number of medication compliance systems have been developed that attempt to address the challenge assisting visually impaired patients in managing their daily regime of prescription drugs, vitamins, etc. Some solution do not account for the capabilities of the majority of the patient population. For instance, products available in Braille are not useful to older Americans who may have developed visual impairment issues until later in life, and thus, never learned Braille. For example, macular degeneration is a common problem among millions of Americans 65 or older.

In order to deal with the problem of providing drug information to the visually impaired patients, a number of non-technical measures are employed. Most often, the visually impaired patient population must rely of verbal counseling from a caregiver, pharmacist or doctor for the proper instruction. Where visual impairment is not yet severe, a magnifying glass may be employed to identity the appropriate medication for purchase or for self-administration. Additionally, patients try themselves to overcome their disability by trying the to memorize the shape of the pill as it feels in their hands because the print is too small and all the bottles are of similar size and shape. The chances of error are great where those living alone must often rely on the memory, reading skills, and good graces of the next visitor to help them if they become confused by the passage of time and the need to memorize other information.

Technological measures have also been employed to address this problem. Alarms and beepers are also used to remind a patient when it is time to medicate. The main problem with conventional drug compliance devices is a lack of real time interactivity from the patient, the patient's doctor and the pharmacist with regard to the patient's drug compliance. Another problem with conventional drug compliance devices is that the devices are not wireless, hence they are not portable, and require the patient's active input to operate. Or, if they are wireless, then they are only pager units that do not hold the patient's medication. A final problem with conventional drug compliance devices is that they are expensive and the cost for the device is borne by the patient/consumer.

In order to overcome the above disadvantages associated with these conventional systems, it is the object of the present invention to provide a practical system for communicating medicine dosage and intake instructions to patient utilizing a device that is equipped the radio frequency identification (RFID) capabilities, such that the RFID capabilities enables the user to identify the proper medicine and triggers audible instructions for use of that medicine to play for the user.

The inventors of the present invention have recognized that by providing radio frequency identification (RFID) enabled mobile phones, new markets can be developed that heretofore have been untapped by the wireless communications industry. As one example, the present invention was developed utilizing typical consumer product mobile phones as a platform for RFID technology.

It is an object of the present invention to permit visually-impaired patients to identify medication and receive dosage and intake instructions via RFID enabled mobile phones. It is a further object of the present invention to assist patient populations that are typically non-compliant with regard to medication regimes due to some other physical or mental ailment, such as lack of memory loss or Alzheimer's, to become compliant with their dosing regime.

### SUMMARY OF THE INVENTION

In order to achieve the objects of the present invention, as described above, the present invention provides, the present invention utilizes RFID-enabled network devices that run computer programs design to communicate a medicine's identity, dosage and intake instructions to a patient in need thereof. In particular, in a first embodiment of the present invention, a method of communicating medicine dosage and intake instructions to patient is provided, comprising:
a. labeling a medicine container with a RFID tag containing a unique identifier;
b. associating the unique identifier with an audio file comprising instructions related to medicine usage; and
c. delivering the audio file to a RFID-enabled device;

wherein a service is initiated to play said audio file when said RFID tag is read by said RFID-enabled device.

In a second embodiment of the present invention, a method of communicating medicine dosage and intake instructions to patient according to the first embodiment above is provided, wherein the RFID-enabled device is a mobile phone.

In a third embodiment of the present invention, a method of communicating medicine dosage and intake instructions to patient according to the second embodiment above is provided, wherein the audio file is played in the form of a ringtone.

In a fourth embodiment of the present invention, a method of communicating medicine dosage and intake instructions to patient according to the second embodiment above is provided, wherein the audio file is played in the form of a voice message.

In a fifth embodiment of the present invention, a network-based computer system for communicating medicine dosage and intake instructions to patient is provided, comprising:
a. a means for delivering an audio file comprising instructions related to medicine usage via a network to a RFID-enabled device;
b. a means for associating the audio file with a RFID tag containing a unique identifier; and
c. a means for playing the audio file when said RFID tag is read by said RFID-enabled device.

In a sixth embodiment of the present invention, a network-based computer system for communicating medicine dosage and intake instructions to patient according to the fifth embodiment is provided, wherein the RFID-enabled device is a mobile phone.

In a seventh embodiment of the present invention, a network-based computer system for communicating medicine dosage and intake instructions to patient according to the sixth embodiment is provided, wherein the audio file is played in the form of a ringtone.

In an eight embodiment of the present invention, a network-based computer system for communicating medicine dosage and intake instructions to patient according to the sixth embodiment is provided, wherein the audio file is played in the form of a voice message.

In a ninth embodiment of the present invention, a computer program product is provided comprising:
a. A computer storage medium;
b. A computer program code mechanism embedded in said computer storage medium for initiating a service that plays an audio file comprising instructions related to medicine usage on a RFID-enabled device when a RFID tag is read by the RFID-enabled device.

In a tenth embodiment of the present invention, a computer program product is provided according to the ninth embodiment is provided, wherein the RFID-enabled device is a mobile phone.

In an eleventh embodiment of the present invention, a computer program product is provided according to the tenth embodiment is provided, wherein the audio file is played in the form of a ringtone.

In a twelfth embodiment of the present invention, a computer program product is provided according to the tenth embodiment is provided, wherein said audio file is played in the form of a voice message.

In thirteenth embodiment of the present invention, an RFID-enabled wireless device is provided comprising:
a processor; and
a computer readable medium encoded with processor readable instructions that when executed by the processor for initiating a service that plays an audio file comprising instructions related to medicine usage when a RFID tag is read by the RFID-enabled wireless device.

In a fourteenth embodiment of the present invention, an RFID-enabled wireless device according to the thirteenth embodiment is provided, wherein the RFID-enabled device is a mobile phone.

In a fifteenth embodiment of the present invention, an RFID-enabled wireless device according to the fourteenth embodiment is provided, wherein the audio file is played in the form of a ringtone.

In a sixteenth embodiment of the present invention, an RFID-enabled wireless device according to the fourteenth embodiment is provided, wherein the audio file is played in the form of a voice message.

In a seventeenth embodiment of the present invention, an RFID-enabled fixed line device is provided comprising:
a processor; and
a computer readable medium encoded with processor readable instructions that when executed by the processor for initiating a service that plays an audio file comprising instructions related to medicine usage when a RFID tag is read by the RFID-enabled fixed line.

In an eighteenth embodiment of the present invention, a fixed line device according to the seventeenth embodiment is provided, wherein the RFID-enabled device is a telephone.

In a nineteenth embodiment of the present invention, a fixed line device according to the eighteenth embodiment is provided, wherein the audio file is played in the form of a ringtone.

In a twentieth embodiment of the present invention, a fixed line device according to the nineteenth embodiment is provided, wherein the audio file is played in the form of a voice message.

### BRIEF DESCRIPTION OF THE DRAWINGS

FIG. 1 is a block diagram of an example wireless communication network according to one embodiment of the invention where audio files are generated by a text to speech process module.

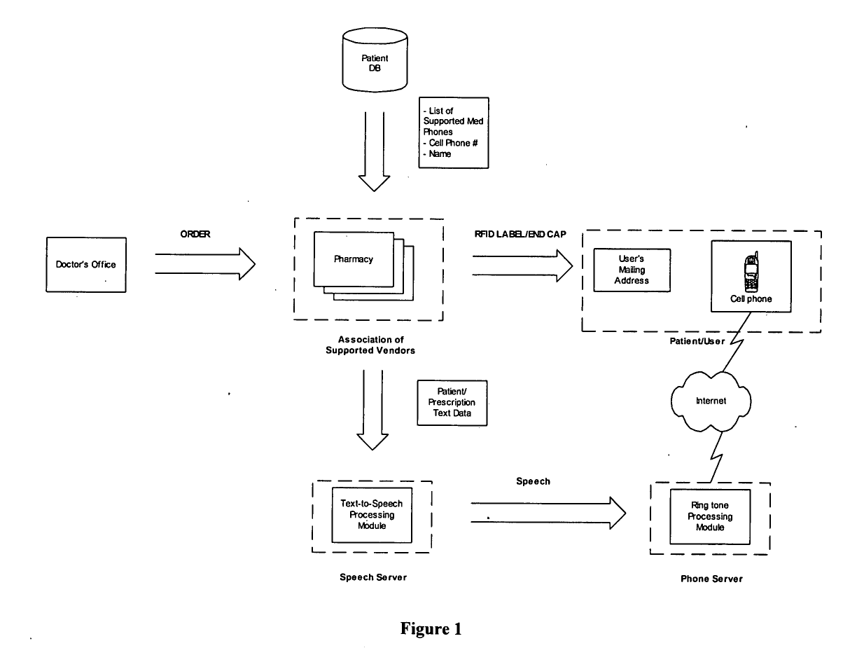

FIG. 2 is a block diagram of an example wireless communication network according to one embodiment of the invention where audio files are accessed from a database.

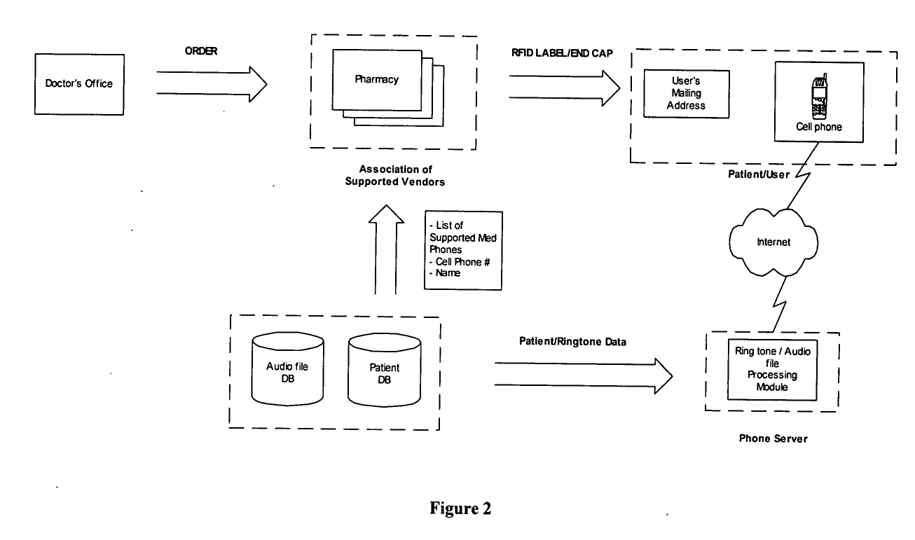

FIG. 3 is a block diagram of an example RFID-enabled mobile phone reading a RFID tag attached to a medicine container.

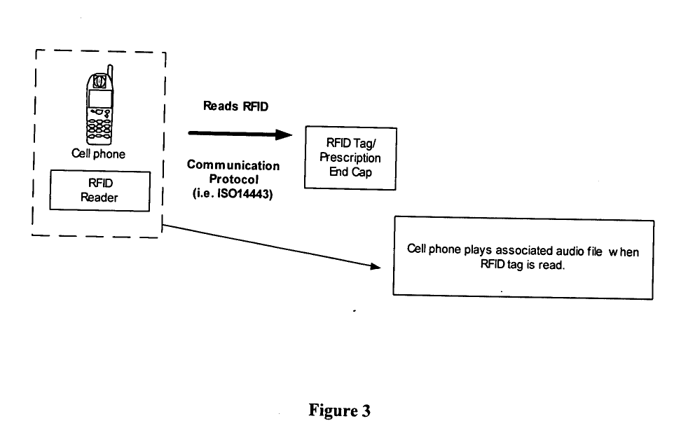

FIG. 4 is a flow chart illustrating an example of steps taken to deliver audio files to a RFID-enable device for communicating medicine identity, dosage and intake instructions to a patient.

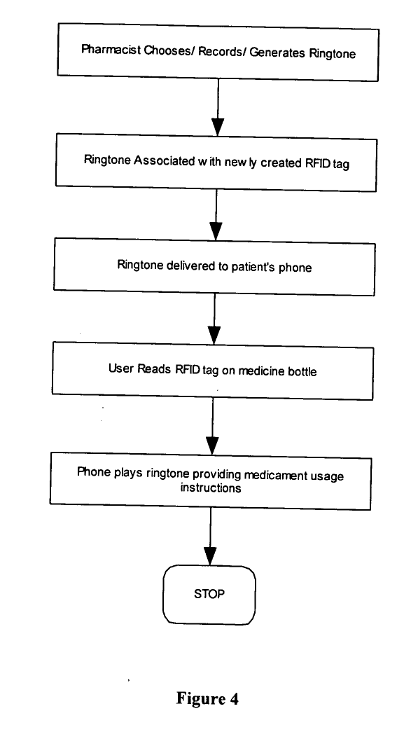

### DETAILED DESCRIPTION OF THE INVENTION

A typical RFID solution consists of a tag and a reader. The reader, when activated, emits a short-range radio signal that powers up the tag, enabling the data on the tag to be read. The present invention utilizes an RFID-enabled networked device that can read information stored on RFID labels or tags. This functionality may be embedded in the networked device or implemented as RFID reader shells. The RIFD reader shells acts as an input accessory for use with a networked device, which runs the software for tag reading. Each tag contains a specific serial number that the device links with initiation of a service. Where a device is a phone, the initiated service may be a call, messaging, browsing or recording data.

The present invention utilizes devices that operate on a network. These networks include networks suitable for the transmission of digital information, which include, but are not limited to, wide area networks (WAN), personal area networks (PANs), metropolitan area networks (MANs), local area networks (LANs) or the public switched telephone network (PSTN).

In the present invention, the networked device is preferably a device linked to a wireless network, or wireless device. The wireless device of the present invention may be any wireless communication device such as a telephone, personal data assistant (PDA), pager, multi-function device, or other communication device.

In a preferred embodiment of the present invention, the wireless device is a mobile phone, such as any common consumer mobile phone product equipped with a microprocessor. A mobile phone, also known as a cellphone or cellular phone, is a portable electronic device which behaves as a normal telephone whilst being able to move over a wide area (compare cordless phone which acts as a telephone only within a limited range). Cellphones allow connections to be made to the telephone network, normally by directly dialing the other party's number on an inbuilt keypad. Most current cellphones use a combination of radio wave transmission and conventional telephone circuit switching, though packet switching is already in use for some parts of the cellphone network, especially for services such as Internet access and WAP.

Wireless Application Protocol (WAP) is an open international standard for applications that use wireless communication, for example Internet access from a mobile phone. WAP was designed to provide services equivalent to a Web browser with some mobile-specific additions, being specifically designed to address the limitations of very small portable devices. It is now the protocol used for the majority of the world's mobile internet sites, otherwise known as wap-sites. The Japanese i-mode system is the other major competing wireless data protocol.

Whereas WAP represents one protocol in wireless communications, the application of the present invention may utilize any of the interfaces or protocols for wireless communications known to the relevant programming community. For example, short message service (SMS) is widely used for delivering to mobile devices premium content, such as ringtones. Other services include enhanced messaging service (EMS) messages, multimedia messaging service (MMS) messages, or other types of messages sent to and/or from wireless devices within the wireless communication network, including, but not limited to immediate messaging (IM) and presence services (IMPS), mobile e-mail, and Internet protocol (IP)-based multimedia service (IMS).

Wireless communications networks are described in more detail in Gralla, P., “How Wireless Works,” Que, 2002, and in particular in Chapters 10 and 11 thereof, and in Le Bodic, G., “Mobile Messaging Technologies and Services: SMS, EMS and MMS,” John Wiley & Sons, Ltd. 2003, and in particular in Chapter 1 thereof, the entire contents of all three of these chapters being incorporated herein by reference.

According to the present invention, a patient will receive their medication in containers that are labeled with an RFID tag. The location of the RFID tag on the container can be anywhere that suits the needs of the distributor of the medication. The RFID tags may be printed with the medicine label or attached to the bottle or cap itself.

When the patient needs to take medication, the patient may use the RFID-enabled network device to read the RFID tag asscoiated with the medicine. That event will then initiate an audio file stored on the RFID-enabled network device to play and communicate the instrustions therein.

In the preferred embodiment, the audio file will play in the form of a ringtone. A ringtone is the sound typically made by a telephone and used to indicate an incoming call. The term is most often used to refer to the customizable sounds available on mobile phones.

In the present invention, audio files are recorded and associated with medication as a means to communicate the identity, dosage and intake instructions for use. An RFID-enabled device communicates medicament instructions by initiating a ringtone mechanism to play the audio file when the RFID tag is read, not as an indication of an incoming call.

Ringtones of the present invention may be monophonic or polyphonic. The ringtones of the present invention may be contained in MP3, WMA, WAV, QCP, or AMR format, but are not limited to these formats.

In another embodiment of the invention, the audio file plays through the earpiece of the mobile phone in the form of a voice message. Once the phone reads the RFID tag, the audio file begins to play through the earpiece of the phone, which the patient then listens to in the normal course of using a phone. Additional features may be added, such as permitting the user to repeat the instructions. That is, once the recording has ended, that caller is given the option of accessing the file again by pressing a key on the keypad or other input source on the device.

The audio files may be created or generated utilizing a number of methods and additional technologies. These included, but are not limited to, simple voice recording and the conversion of text information to audio speech by an embedded text-to-speech processor. Examples of text-to-speech processors include TMS320C203 from Texas Instruments, V8600 from RC Systems, and MSM7630 from OKI Semiconductor.

The audio files may be stored in the database for retrieval by a user, such as a pharmacist, at the time the ringtone is associated with the RFID tag. Alternatively, the pharmacist may customize instructions at the time the prescriptions are filed. The pharmacist may make a voice recording or utilize other technology that permits the transformation of written text into speech. If not already, this generated audio file is then converted into a format suitable for use as a ringtone.

The ringtones or audio files of the present invention may be delivered to mobile phones in the normal course over wireless communication networks. Alternatively, equiping phones with Bluetooth (or other specification for wireless PAN) or PC-link up would premit users to transfer ringtones created on a PC (personal computer), to their phone.

WAP Push, available since WAP 1.2, has been incorporated into the specification to allow WAP content to be pushed to the mobile handset with minimum user intervention. A WAP Push is basically a specially encoded message which includes a link to a WAP address. In addition to SMS mentioned above, WAP Push represents another means by which to deliver content to wireless devices over a wireless network.

The operation of the wireless device is controlled by the microprocessor programmed with instructions that are stored in memory. The memory holds data that is accessible by application operating on the wireless device. For example, a mobile phone may store a phone book that can be maintained by the user. Software applications that are run by the microprocessor may access this data in memory. Those of ordinary skill in the art would understand that common applications for a wireless device, such as a mobile phone, are readily programmable.

In the present invention, an application running on a wireless device would respond to an RFID tag reading event. When a RFID tag is read, data, including a unique tag identifier such as a serial number, is transferred and captured by the wireless device. In one embodiment of the present invention, that unique tag identifier is assigned to a ringtone that is then played by the wireless device. By recognizing the unique tag identifier, a simple comparison is made in a database to determine if an entry exists for that particular tag, and if so, which ringtone has been assigned to it. If there has been such an assignment, the selected ringtone is played. If not, a default message corresponding to a particular event is played.

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

Although focus has been given to wireless devices and communications and the advantages these technologies offer, the present invention is not limited to wireless devices, but rather may also be carried out using non-wireless communication devices, such as a processor-equipped telephone connected to a public switched telephone network (PSTN). An example of such a fixed line device would be a telephone equipped to receive digital information via a network where the audio file is stored in memory and when initiated by an RFID read event, is disseminated through a speaker, in the case of a ringtone, or through the earpiece in case of the voice message.

In addition, RFID technology also permits the recording of data. Thus, patient compliance data may be recorded. For example, when the patient reads the RIFD tag associated with a particular medicine, a date stamp may be associated with the occurrence and recorded. This record may be stored in the phones memory or sent as a file to a storage device or as a message to a caregiver. In this manner, information regarding how many times a patient has taken their medication may be recorded and communicated to the patient or appropriate caregiver or medical personnel.

In another embodiment, it is envisioned that the device and software of the current invention also comprises an alarm function, which provides an audible signal indicating to the user that it is time to take a specific drug or regime of drugs. The audible signal may be a ringtone, voice message, or other sound used for purposes of alerting an individual. In this regard, the current invention signals the patient at the appropriate time according to a preset dosing schedule. Recording the patient's acknowledgment of the alarm may be used as a means monitor the patient's compliance. Patient's acknowledgement may be recorded at the press of a button, or preferably, and recorded at the time the user scans proper medicine(s). This alarm function may be controlled remotely where the dosage schedule is pushed to the phone, or may be controlled locally by the patient.

RFID technology, for delivery of the medicine dosage, is but one example of a wireless technology for data delivery, but can be extended to any frequency in the electromagnetic spectrum. It should be understood that this invention is not limited to the particular embodiments disclosed, but it is intended to cover modifications within the spirit and scope of the present invention as defined by the appended claims.

What is claimed is:

1. A method of communicating medicine dosage and intake instructions to person, comprising:
a. labeling a medicine container with a tag containing a unique identifier, said tag is identified by electromagnetic waves;
b. associating said unique identifier with an audio file comprising instructions related to medicine usage; and
c. delivering said audio file to a electromagnetic enabled device; wherein a service is initiated to play said audio file when said tag is read by said device.

2. The method according to claim 1, wherein said device is a mobile device.

3. The method according to claim 2, wherein said audio file is played in the form of a ringtone.

4. The method according to claim 2, wherein said audio file is played in the form of a voice message.

5. A network-based computer system for communicating medicine dosage and intake instructions to patient, comprising:
a. a subsystem for delivering an audio file comprising instructions related to medicine usage via a network to a RFID-enabled device;
b. a subsystem for associating said audio file with a RFID tag containing a unique identifier; and
c. a subsystem for playing said audio file when said RFID tag is read by said RFID-enabled device.

6. The network-based computer system according to claim 5, wherein said device is a mobile device.

7. The network-based computer system according to claim 6, wherein said audio file is played in the form of a ringtone.

8. The network-based computer system according to claim 6, wherein said audio file is played in the form of a voice message.

9. A computer product comprising:
a computer storage medium; and
a computer program code mechanism embedded in said computer storage medium for initiating a service that plays an audio file comprising instructions related to medicine usage on a RFID-enabled device when a RFID tag is read by said RFID-enabled device.

10. The computer program product of claim 9, wherein said RFID-enabled device is a mobile phone.

11. The computer program product of claim 10, wherein said audio file is played in the form of a ringtone.

12. The computer program product of claim 10, wherein said audio file is played in the form of a voice message.

13. An electromagnetic wave enabled wireless device comprising:
a processor; and
a computer readable medium comprising instructions that when executed by the processor causes a service to play an audio file comprising instructions related to medicine usage when a tag is read by said wireless device.

14. The wireless device of claim 13, wherein said device is a mobile device.

15. The wireless device of claim 14, wherein said audio file is played in the form of a ringtone.

16. The wireless device of claim 14, wherein said audio file is played in the form of a voice message.

17. An electromagnetic wave-enabled device comprising:
a processor; and
a computer readable medium encoded with processor readable instructions that when executed by the processor for initiating a service that plays an audio file comprising instructions related to medicine usage when a RFID tag is read by said electromagnetic wave-enabled device.

18. The device of claim 17, wherein said RFID-enabled device is a telephone.

19. The device of claim 18, wherein said audio file is played in the form of a ringtone.

20. The device of claim 18, wherein said audio file is played in the form of a voice message.
